(19) United States
(12) Patent Application Publication
(10) Pub. No.: US 2026/0031515 A1
(43) Pub. Date: Jan. 29, 2026

(54) SECONDARY BATTERY AND ELECTRONIC DEVICE

(71) Applicant: Ningde Amperex Technology Limited, Ningde (CN)

(72) Inventor: Kewen HU, Ningde (CN)

(73) Assignee: Ningde Amperex Technology Limited, Ningde (CN)

(21) Appl. No.: 19/342,961

(22) Filed: Sep. 29, 2025

Related U.S. Application Data
(63) Continuation of application No. PCT/CN2023/085782, filed on Mar. 31, 2023.

(51) Int. Cl. H01M 50/595; H01M 10/0525; H01M 50/121

(52) U.S. Cl. CPC H01M 50/595; H01M 10/0525; H01M 50/121

(57) ABSTRACT

An secondary battery includes an electrode assembly, an electrolyte solution, a housing, and an adhesive member. The adhesive member is disposed between the electrode assembly and the housing. The adhesive member includes a first adhesive layer and a second adhesive layer stacked up. The first adhesive layer is bonded to an inner surface of the housing. The second adhesive layer is bonded to an outer surface of the electrode assembly. The first adhesive layer includes poly(styrene-b-isoprene-b-styrene) and a first resin. The first resin includes at least one of poly(acrylonitrile-co-butadiene-co-styrene), polyurethane, or polystyrene. The secondary battery provided in this application includes an adhesive member, thereby reducing the probability of tearing of an outer surface of the electrode assembly and the risk of bursting a top seal of the secondary battery and leaking an electrolyte solution, and improving the safety performance of the secondary battery.

### CROSS REFERENCE TO RELATED APPLICATIONS

This application is a continuation application of International Application No. PCT/CN2023/085782, filed on Mar. 31, 2023, the contents of which are incorporated herein by reference in its entirety.

### TECHNICAL FIELD

This application relates to the electrochemical field, and in particular, to a secondary battery and an electronic device.

### BACKGROUND

In a secondary battery such as a lithium-ion battery, due to a clearance between an electrode assembly and a packaging housing, the electrode assembly may move relative to the housing. Therefore, an adhesive member (such as adhesive tape) is required to provide insulation protection and fixation for the lithium-ion battery.

Commonly used adhesive tapes, such as poly(styrene-b-isoprene-b-styrene) (SIS) tape, incurs a problem of a poor restraining effect on the electrode assembly. During a drop of the lithium-ion battery, such as a drop on the head, tail, or side of the battery, the edges of the adhesive tape are subjected to high stress, and the bonding interface between the SIS adhesive tape and the electrode assembly is prone to be damaged, thereby resulting in voltage failure, short circuits, and other problems of the lithium-ion battery, and affecting the safety performance of the lithium-ion battery.

### SUMMARY

An objective of this application is to provide a secondary battery and an electronic device to improve the safety performance of the secondary battery. Specific technical solutions are as follows:

A first aspect of this application provides a secondary battery. The secondary battery includes an electrode assembly, an electrolyte solution, a housing, and an adhesive member. The adhesive member is disposed between the electrode assembly and the housing. The adhesive member includes a first adhesive layer and a second adhesive layer stacked up. The first adhesive layer is bonded to an inner surface of the housing. The second adhesive layer is bonded to an outer surface of the electrode assembly. The first adhesive layer includes poly(styrene-b-isoprene-b-styrene) and a first resin. The first resin includes at least one of poly(acrylonitrile-co-butadiene-co-styrene), polyurethane, or polystyrene. In the secondary battery provided in this application, the first adhesive layer includes the above substances, thereby increasing a friction coefficient between the first adhesive layer and the inner surface of the housing. On the one hand, this reduces the stress at the edge of the adhesive member, reduces the probability of damage to a bonding interface between the adhesive member and the electrode assembly, and consequently reduces the probability of tearing the outer surface of the electrode assembly. On the other hand, this defers the relative movement between the electrode assembly and the housing, thereby reducing the risk of bursting the top seal of the secondary battery and leaking the electrolyte solution, and consequently improving the safety performance of the secondary battery.

In some embodiments of this application, based on a mass of the first adhesive layer, a mass percent of the poly(styrene-b-isoprene-b-styrene) is 32.5% to 75%, and a mass percent of the first resin is 15% to 45%. By controlling the content of the poly(styrene-b-isoprene-b-styrene) and the content of the first resin to fall within the ranges specified herein, this application can increase a friction coefficient between the first adhesive layer and the inner surface of the housing. On the one hand, this reduces the stress at the edge of the adhesive member and reduces the probability of damage to the bonding interface between the adhesive member and the electrode assembly, thereby reducing the probability of tearing the outer surface of the electrode assembly. On the other hand, this defers the relative movement between the electrode assembly and the housing, thereby reducing the risk of bursting the top seal of the secondary battery and leaking the electrolyte solution, and consequently improving the safety performance of the secondary battery.

In some embodiments of this application, based on a mass of the first adhesive layer, a mass percent of the first resin is 20% to 40%. By controlling the mass percent of the first resin to fall within the above range, this application can further improve the safety performance of the secondary battery.

In some embodiments of this application, based on a mass of the first adhesive layer, a mass percent of the first resin is 25% to 35%. By controlling the mass percent of the first resin to fall within the above range, this application can further improve the safety performance of the secondary battery.

In some embodiments of this application, the first adhesive layer further includes a functional resin. A mass percent of the functional resin is 5% to 25% based on a mass of the first adhesive layer. The functional resin includes at least one of poly(ethylene-co-vinyl acetate), a polyurethane elastomer, polyurethane acrylate, polyisobutylene, or polybutadiene. By controlling the mass percent of the functional resin to fall within the above range and selecting the above materials, this application can improve the bonding stability of the first adhesive layer during long-term immersion in an electrolyte solution at a high temperature, thereby improving the safety performance of the secondary battery.

In some embodiments of this application, the first adhesive layer further includes an additive and an antioxidant. Based on a mass of the first adhesive layer, a mass percent of the additive is 1% to 5%, and a mass percent of the antioxidant is 1% to 5%. The first adhesive layer includes an additive and an antioxidant, and the contents thereof are controlled to fall within the above ranges, thereby improving the heat resistance of the first adhesive layer and the oxidation resistance thereof in the electrolyte solution, and consequently improving the bonding performance of the first adhesive layer and improving the safety performance of the secondary battery. In some embodiments of this application, the adhesive member further includes a substrate layer. The substrate layer is located between the first adhesive layer and the second adhesive layer. The substrate layer includes at least one of polyethylene terephthalate, polyimide, or polypropylene. The adhesive member includes a substrate layer and is made of the above materials, thereby increasing the friction between the adhesive member and the housing, thereby improving the safety performance of the secondary battery.

In some embodiments of this application, an area of the first adhesive layer is S₁, an area of an orthographic projection of the electrode assembly along a stacking direction of the electrode assembly, the adhesive member, and the housing is S₂, and S₁/S₂ satisfies 10%≤S₁/S₂≤95%. By controlling the value of S₁/S₂ to fall within the above range, this application can improve the safety performance of the secondary battery.

In some embodiments of this application, the housing is a packaging bag. When the adhesive member of this application is applied to a secondary battery with a housing as a packaging bag, the secondary battery achieves a high energy density and good safety performance.

In some embodiments of this application, a thickness of the first adhesive layer is 2 μm to 20 μm. By controlling the thickness of the first adhesive layer to fall within the above range, this application can reduce the loss of energy density of the secondary battery while improving the safety performance of the secondary battery.

In some embodiments of this application, peel strength between the adhesive member and the housing is 10 N/m to 500 N/m. By controlling the peel strength between the adhesive member and the housing to fall within the above range, this application can reduce the probability of damage to the bonding interface between the adhesive member and the electrode assembly, thereby improving the safety performance of the secondary battery.

In some embodiments of this application, an electrolyte retention coefficient of the secondary battery is 1 g/Ah to 2.5 g/Ah. The electrolyte retention coefficient of the secondary battery falling within the above range makes it convenient for the first resin in the first adhesive layer to swell in the electrolyte solution, thereby further increasing the friction coefficient between the first adhesive layer and the inner surface of the housing, alleviating the problems such as bulges and undesirable electrolyte-induced expansion of the secondary battery, and consequently improving the safety performance of the secondary battery.

A second aspect of this application provides an electronic device, including the secondary battery according to the first aspect of this application. The secondary battery of this application is of high safety performance, and therefore, the electronic device provided in the second aspect of this application achieves a relatively long service life.

This application provides a secondary battery and an electronic device. The secondary battery includes an electrode assembly, an electrolyte solution, a housing, and an adhesive member. The adhesive member is disposed between the electrode assembly and the housing. The adhesive member includes a first adhesive layer and a second adhesive layer stacked up. The first adhesive layer is bonded to an inner surface of the housing. The second adhesive layer is bonded to an outer surface of the electrode assembly. The first adhesive layer includes poly(styrene-b-isoprene-b-styrene) and a first resin. The first resin includes at least one of poly(acrylonitrile-co-butadiene-co-styrene), polyurethane, or polystyrene. The first adhesive layer includes the first resin. The molecular chain of the first resin exhibits high flexibility and low cohesion, so that the first adhesive layer can quickly exert viscosity at low temperature and is highly flexible at high temperature, thereby achieving stability of bonding performance. In the secondary battery provided in this application, the first resin in the first adhesive layer swells in the electrolyte solution, thereby increasing a friction coefficient between the first adhesive layer and the inner surface of the housing. On the one hand, this reduces the stress at the edge of the adhesive member, reduces the probability of damage to a bonding interface between the adhesive member and the electrode assembly, and consequently reduces the probability of tearing the outer surface of the electrode assembly. On the other hand, this defers the relative movement between the electrode assembly and the housing, thereby reducing the risk of bursting the top seal of the secondary battery and leaking the electrolyte solution, and consequently improving the safety performance of the secondary battery.

### BRIEF DESCRIPTION OF DRAWINGS

The drawings described herein are intended to enable a further understanding of this application, and constitute a part of this application. The exemplary embodiments of this application and the description thereof are intended to explain this application but not to constitute any undue limitation on this application.

FIG. 1 is a schematic diagram of a stacked structure of an adhesive member according to an embodiment of this application;

FIG. 2 is a schematic diagram of intermolecular spacing of a first resin before and after swelling in the electrolyte solution;

FIG. 3 is a schematic diagram of a stacked structure of an adhesive member according to another embodiment of this application; and

FIG. 4 is a schematic diagram of an adhesive member bonded to an outer surface of an electrode assembly according to an embodiment of this application.

List of reference signs: adhesive member 10, first adhesive layer 11, second adhesive layer 12, substrate layer 13, electrode assembly 20, pre-swelling first resin 30, post-swelling first resin 31

### DETAILED DESCRIPTION

To make the objectives, technical solutions, and advantages of this application clearer, the following describes this application in more detail with reference to drawings and embodiments. Evidently, the described embodiments are merely a part of but not all of the embodiments of this application. All other embodiments derived by a person of ordinary skill in the art based on the embodiments of this application without making any creative efforts fall within the protection scope of this application.

It is hereby noted that in specific embodiments of this application, this application is construed by using a lithium-ion battery as an example of the secondary battery, but the secondary battery of this application is not limited to the lithium-ion battery.

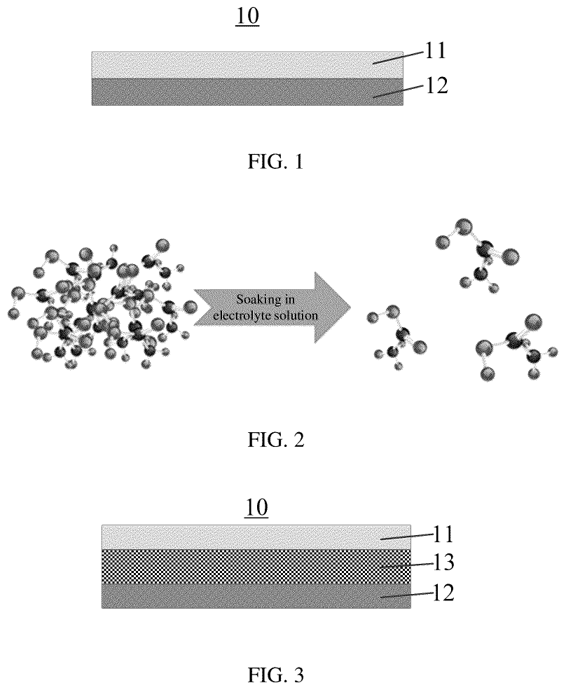

A first aspect of this application provides a secondary battery. The secondary battery includes an electrode assembly, an electrolyte solution, a housing, and an adhesive member. The adhesive member is disposed between the electrode assembly and the housing. As shown in FIG. 1, the adhesive member 10 includes a first adhesive layer 11 and a second adhesive layer 12 stacked up. The first adhesive layer 11 is bonded to an inner surface of the housing. The second adhesive layer 12 is bonded to an outer surface of the electrode assembly. The first adhesive layer 11 includes poly(styrene-b-isoprene-b-styrene) and a first resin. The first resin includes at least one of poly(acrylonitrile-co-butadiene-co-styrene), polyurethane, or polystyrene. The first adhesive layer includes the first resin. The molecular chain of the first resin exhibits high flexibility and low cohesion, so that the first adhesive layer can quickly exert viscosity at low temperature and is highly flexible at high temperature, thereby achieving stability of bonding performance. In the secondary battery provided in this application, the first adhesive layer includes the above substances, and the content thereof is controlled to fall within the range specified herein. The first resin in the first adhesive layer swells in the electrolyte solution. As shown in FIG. 2, the intermolecular spacing of the first resin 30 before swelling is relatively fixed. After swelling in the electrolyte solution, the relatively fixed spacing between the molecules of the swollen first resin 31 is squeezed and amplified by small molecules of the electrolyte solution. The swelling of the first resin can increase friction, thereby increasing the friction coefficient between the first adhesive layer and the inner surface of the housing. In the secondary battery provided in this application, the first adhesive layer includes the first resin, thereby achieving both a desirable friction coefficient between the first adhesive layer and the inner surface of the housing and desirable peel strength between the adhesive member and the housing. On the one hand, this reduces the stress at the edge of the adhesive member, reduces the probability of damage to a bonding interface between the adhesive member and the electrode assembly, and consequently reduces the probability of tearing the outer surface of the electrode assembly. On the other hand, this defers the relative movement between the electrode assembly and the housing, thereby reducing the risk of bursting the top seal of the secondary battery and leaking the electrolyte solution, and consequently improving the safety performance of the secondary battery.

In some embodiments of this application, based on the mass of the first adhesive layer, the mass percent of the poly(styrene-b-isoprene-b-styrene) is 32.5% to 75%, and the mass percent of the first resin is 15% to 45%. Preferably, the mass percent of the first resin is 20% to 40%, and further preferably, the mass percent of the first resin is 25% to 35%. For example, the mass percent of the poly(styrene-b-isoprene-b-styrene) may be 32.5%, 35%, 45%, 50%, 55%, 65%, 75%, or a value falling within a range formed by any two thereof, and the mass percent of the first resin may be 15%, 20%, 25%, 27%, 30%, 33%, 35%, 40%, 45%, or a value falling within a range formed by any two thereof. By controlling the content of the poly(styrene-b-isoprene-b-styrene) and the content of the first resin to fall within the ranges specified herein, this application can increase the friction coefficient between the first adhesive layer and the inner surface of the housing. On the one hand, this reduces the stress at the edge of the adhesive member and reduces the probability of damage to the bonding interface between the adhesive member and the electrode assembly, thereby reducing the probability of tearing the outer surface of the electrode assembly. On the other hand, this defers the relative movement between the electrode assembly and the housing, thereby reducing the risk of bursting the top seal of the secondary battery and leaking the electrolyte solution, and consequently improving the safety performance of the secondary battery. When the first resin includes two or more of the poly(acrylonitrile-co-butadiene-co-styrene), polyurethane, or polystyrene, the content of each of such substances is not particularly limited, as long as the objectives of this application can be achieved.

In this application, the monomers of the poly(acrylonitrile-co-butadiene-co-styrene) include acrylonitrile, butadiene, and styrene. Based on the mass of the poly(acrylonitrile-co-butadiene-co-styrene), the mass percent of acrylonitrile is 5% to 35%, the mass percent of butadiene is 20% to 55%, and the mass percent of styrene is 10% to 45%. By controlling the mass percentages of the monomers—acrylonitrile, butadiene, and styrene—of the poly(acrylonitrile-co-butadiene-co-styrene) to fall within the above ranges, this application improves the overall performance of the first resin. For example, the first resin is of high chemical resistance, high thermal stability, high elasticity, high toughness, relatively high hardness, and high processability, where the acrylonitrile provides chemical resistance and thermal stability, the butadiene provides high elasticity and toughness, and the styrene provides high hardness and processability, thereby improving the bonding performance of the first adhesive layer, alleviating the problems of undesirable electrolyte-induced expansion on the surface and four corners of the electrode assembly, increasing the friction coefficient between the first adhesive layer and the inner surface of the housing, reducing the probability of tearing the outer surface of the electrode assembly and the risk of bursting the top seal of the secondary battery and leaking the electrolyte solution, and improving the safety of the secondary battery.

In this application, the friction coefficient between the first adhesive layer and the inner surface of the housing is 0.3 to 0.9. This indicates that the friction coefficient between the first adhesive layer and the inner surface of the housing is relatively large. On the one hand, this reduces the stress at the edge of the adhesive member, reduces the probability of damage to a bonding interface between the adhesive member and the electrode assembly, and consequently reduces the probability of tearing the outer surface of the electrode assembly. On the other hand, this defers the relative movement between the electrode assembly and the housing, thereby reducing the risk of bursting the top seal of the secondary battery and leaking the electrolyte solution, and consequently improving the safety performance of the secondary battery.

In some embodiments of this application, the first adhesive layer further includes a functional resin. The mass percent of the functional resin is 5% to 25% based on the mass of the first adhesive layer. For example, the mass percent of the functional resin may be 5%, 10%, 12%, 15%, 18%, 20%, 25%, or a value falling within a range formed by any two thereof. The functional resin includes at least one of poly(ethylene-co-vinyl acetate), a polyurethane elastomer, polyurethane acrylate, polyisobutylene, or polybutadiene. By controlling the mass percent of the functional resin to fall within the above range and selecting the above materials, this application can improve the morphological stability of the first adhesive layer during long-term immersion in an electrolyte solution at a high temperature, and improve the bonding performance of the first adhesive layer, thereby improving the safety performance of the secondary battery. As used herein, the term “high temperature” means 80° C. to 90° C.

In some embodiments of this application, the first adhesive layer further includes an additive and an antioxidant. Based on the mass of the first adhesive layer, the mass percent of the additive is 1% to 5%, and the mass percent of the antioxidant is 1% to 5%. The mass percent of the additive may be 1%, 2%, 3%, 4%, 5%, or a value falling within a range formed by any two thereof. The mass percent of the antioxidant may be 1%, 2%, 3%, 4%, 5%, or a value falling within a range formed by any two thereof. The types of the additive and the oxidant are not particularly limited herein, as long as the objectives of this application can be achieved. The additive may include, but is not limited to, at least one of titanium dioxide powder, talcum powder, white carbon black, or calcium carbonate. The antioxidant may include, but is not limited to, at least one of diphenylamine, triester phosphite, or distearyl thiodipropionate. The first adhesive layer includes an additive and an antioxidant, and the contents thereof are controlled to fall within the above ranges, thereby improving the heat resistance of the first adhesive layer and the oxidation resistance thereof in the electrolyte solution, and consequently improving the bonding performance of the first adhesive layer, improving the stability of the first adhesive layer, and improving the safety performance of the secondary battery.

In some embodiments of this application, as shown in FIG. 3, the adhesive member 10 further includes a substrate layer 13. The substrate layer 13 is located between the first adhesive layer 11 and the second adhesive layer 12. The substrate layer includes at least one of polyethylene terephthalate, polyimide, or polypropylene. The content of the above substances in the substrate layer is not particularly limited herein, and may be adjusted by a person skilled in the art as actually required, as long as the objectives of this application can be achieved. The weight-average molecular weight of the above substances in the substrate layer is not particularly limited herein, and may be selected by a person skilled in the art as actually required, as long as the objectives of this application can be achieved. For example, the weight-average molecular weight may be 10,000 to 500,000. When the substrate layer contains a plurality of the above substances, the content of each substance is not particularly limited, as long as the objectives of this application can be achieved. The adhesive member includes a substrate layer, and the above materials are selected, so that the adhesive member possesses a specific level of hardness, thereby alleviating the problems of wrinkling and bubbling during bonding, broadening the process window of the adhesive member, enabling both face pressing and roll pressing, and effectively preventing foreign matters such as burrs and debris, protecting the electrode assembly, and consequently improving the safety performance of the secondary battery.

The substrate layer of this application may further include a colorant such as cobalt green, cobalt blue, Prussian blue, indigo, and phthalocyanine blue, so that the substrate takes on a color. In this way, the substrate layer can be identified by an electronic device such as an inductively coupled device (CCD) or an active pixel sensor (CMOS) during production, so as to determine a bonding site, affix the adhesive, detect omissions, and the like. The content of the colorant in the substrate layer is not particularly limited herein, and may be adjusted by a person skilled in the art as actually required, as long as the objectives of this application can be achieved.

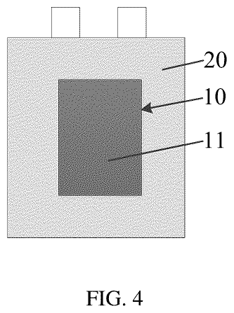

In some embodiments of this application, as shown in FIG. 4, the adhesive member 10 is bonded to the outer surface of the electrode assembly 20. The area of the first adhesive layer 11 is S₁, the area of an orthographic projection of the electrode assembly 20 along a stacking direction of the electrode assembly 20, the adhesive member 10, and the housing is S₂, and S₁/S₂ satisfies 10%≤S₁/S₂≤95%. For example, the value of S₁/S₂ may be 10%, 15%, 25%, 35%, 40%, 45%, 55%, 65%, 75%, 85%, 95%, or a value falling within a range formed by any two thereof. By controlling the value of S₁/S₂ to fall within the above range, this application achieves high peel strength between the adhesive member and the housing, without affecting packaging due to an excessive size of the adhesive member, thereby improving the safety performance and processing performance of the secondary battery.

In some embodiments of this application, the housing is a packaging bag. For example, the packaging bag may be an aluminum laminated film packaging bag. When the adhesive member of this application is applied to a secondary battery with a housing as a packaging bag, the secondary battery achieves a high energy density and good safety performance.

In some embodiments of this application, the thickness of the first adhesive layer is 2 μm to 20 μm. For example, the thickness of the first adhesive layer may be 2 μm, 4 μm, 7 μm, 10 μm, 14 μm, 18 μm, 20 μm, or a value falling within a range formed by any two thereof. By controlling the thickness of the first adhesive layer to fall within the above range, this application can reduce the loss of energy density of the secondary battery while improving the safety performance of the secondary battery.

The thickness of the second adhesive layer and the thickness of the substrate layer are not particularly limited herein, as long as the objectives of this application can be achieved. For example, the thickness of the second adhesive layer is 2 μm to 10 μm, and the thickness of the substrate layer is 4 μm to 30 μm.

In some embodiments of this application, the peel strength between the adhesive member and the housing is 10 N/m to 500 N/m. For example, the peel strength between the adhesive member and the housing may be 10 N/m, 30 N/m, 50 N/m, 70 N/m, 100 N/m, 150 N/m, 200 N/m, 250 N/m, 300 N/m, 400 N/m, 500 N/m, or a value falling within a range formed by any two thereof. By controlling the peel strength between the adhesive member and the housing to fall within the above range, this application can alleviate the problem of tearing the surface of an electrode plate at the edge of the adhesive member, thereby improving the safety performance of the secondary battery.

In some embodiments of this application, the electrolyte retention coefficient of the secondary battery is 1 g/Ah to 2.5 g/Ah. For example, the electrolyte retention coefficient of the secondary battery may be 1 g/Ah, 1.2 g/Ah, 1.5 g/Ah, 1.7 g/Ah, 2 g/Ah, 2.3 g/Ah, 2.5 g/Ah, or a value falling within a range formed by any two thereof. The electrolyte retention coefficient of the secondary battery falling within the above range makes it convenient for the first resin in the first adhesive layer to swell in the electrolyte solution, thereby further increasing the friction coefficient between the first adhesive layer and the inner surface of the housing, alleviating the problems such as bulges and undesirable electrolyte-induced expansion of the secondary battery, and consequently improving the safety performance of the secondary battery.

The method for preparing the adhesive member is not particularly limited herein, as long as the objectives of this application can be achieved. For example, in this application, the adhesive member may be prepared by using the following method: mixing well poly(styrene-b-isoprene-b-styrene), a first resin, a functional resin, an additive, and an antioxidant, hot-melting the mixture at a temperature of 100° C. to 150° C., and then applying the hot-melted product onto one surface of the substrate layer, and drying the hot-melted product to form a first adhesive layer; and applying the material of a second adhesive layer onto the other surface of the substrate layer, and drying the material to form a second adhesive layer to obtain an adhesive member.

The weight-average molecular weights of the poly(styrene-b-isoprene-b-styrene), the first resin, and the functional resin are not particularly limited herein. A person skilled in the art may make a selection as actually required, as long as the objectives of this application can be achieved. For example, the weight-average molecular weight of the poly(styrene-b-isoprene-b-styrene) may be 50,000 to 150,000, the weight-average molecular weight of the first resin may be 10,000 to 500,000, and the weight-average molecular weight of the functional resin may be 100,000 to 300,000. The material of the second adhesive layer is not particularly limited herein, as long as the objectives of this application can be achieved. For example, the material of the second adhesive layer may include at least one of polymethyl methacrylate (PMMA, informally known as acrylic), polypropylene (PP), polyethylene (PE), or polyamide.

The secondary battery of this application includes an electrode assembly, an electrolyte solution, a housing, and an adhesive member. The electrode assembly and the electrolyte solution are accommodated in the housing. The structure of the electrode assembly is not particularly limited in this application, as long as the objectives of this application can be achieved. For example, the structure of the electrode assembly is a stacked structure or a jelly-roll structure. The electrode assembly includes a positive electrode plate, a negative electrode plate, and the separator. The separator is disclosed between the positive electrode plate and the negative electrode plate. The separator is configured to separate the positive electrode plate from the negative electrode plate, prevent a short circuit inside the secondary battery, and allow electrolyte ions to pass freely without affecting the electrochemical charge and discharge processes.

The positive electrode plate is not particularly limited herein, as long as the objectives of this application can be achieved. For example, the positive electrode plate includes a positive current collector and a positive active material layer disposed on at least one surface of the positive current collector. The positive current collector is not particularly limited herein, as long as the objectives of this application can be achieved. For example, the positive current collector may include aluminum foil, aluminum alloy foil, or the like. The positive active material layer in this application includes a positive active material. The type of the positive active material is not particularly limited herein, as long as the objectives of this application can be achieved. For example, the positive active material may include at least one of lithium nickel cobalt manganese oxide (NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the thicknesses of the positive current collector and the positive active material layer are not particularly limited, as long as the objectives of this application can be achieved. For example, the thickness of the positive current collector is 4 μm to 20 μm, and preferably 4 μm to 18 μm. The thickness of the positive active material layer on a single side is 30 μm to 120 μm. In this application, the positive active material layer may be disposed on one surface of the positive current collector in a thickness direction or on both surfaces of the positive current collector in the thickness direction. It is hereby noted that the “surface” here may be the entire region of the positive current collector, or a partial region of the positive current collector, without being particularly limited herein, as long as the objectives of the application can be achieved. The positive active material layer in this application may include a conductive agent and a binder. The conductive agent and binder are not particularly limited as long as the objectives of this application can be achieved. For example, the conductive agent may include at least one of conductive carbon black (Super P), carbon nanotubes (CNTs), carbon nanofibers, flake graphite, carbon dots, graphene, or the like. The binder may include at least one of polypropylene alcohol, sodium polyacrylate, potassium polyacrylate, lithium polyacrylate, polyimide, polyamide imide, styrene butadiene rubber (SBR), polyvinyl alcohol (PVA), polyvinylidene difluoride (PVDF), polytetrafluoroethylene (PTFE), polyvinyl butyral (PVB), water-based acrylic resin, lithium carboxymethyl cellulose (CMC-Li), sodium carboxymethyl cellulose (CMC-Na), or the like.

The negative electrode plate is not particularly limited herein, as long as the objectives of this application can be achieved. For example, the negative electrode plate includes a negative current collector and a negative active material layer disposed on at least one surface of the negative current collector. The negative current collector is not particularly limited herein, as long as the objectives of this application can be achieved. For example, the negative current collector may include a copper foil, copper alloy foil, nickel foil, stainless steel foil, titanium foil, foamed nickel, foamed copper, or the like. The negative active material layer in this application includes a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ (0<x≤2), Li—Sn alloy, Li—Sn—O alloy, Sn, SnO, SnO₂, spinel-structured lithium titanium oxide Li₄Ti₅Oi₂, Li—Al alloy, or metallic lithium. The thicknesses of the negative current collector and the negative active material layer are not particularly limited herein, as long as the objectives of this application can be achieved. For example, the thickness of the negative current collector is 4 μm to 10 μm, and the thickness of the negative active material layer is 30 μm to 130 μm. In this application, the negative active material layer may be disposed on one surface of the negative current collector in the thickness direction or on both surfaces of the negative current collector in the thickness direction. It is hereby noted that the “surface” here may be the entire region of the negative current collector, or a partial region of the negative current collector, without being particularly limited herein, as long as the objectives of the application can be achieved. Optionally, the negative active material layer may further include a conductive agent and a binder. The types of the conductive agent and the binder in the negative active material layer are not particularly limited herein, as long as the objectives of this application can be achieved. For example, the negative active material layer of this application may include the above-mentioned conductive agent and binder. The mass ratio between the negative active material, the conductive agent, and the binder in the negative active material layer is not particularly limited herein, as long as the objectives of this application can be achieved.

The separator is not particularly limited herein as long as the objectives of this application can be achieved. For example, the separator may be made of a material including, but not limited to, at least one of polyethylene (PE)-based, polypropylene (PP)-based, or polytetrafluoroethylene-based polyolefin (PO) separator, a polyester film (such as polyethylene terephthalate (PET) film), a cellulose film, a polyimide film (PI), a polyamide film (PA), or a spandex or aramid film. The type of the separator may include, but is not limited to, a woven film, a nonwoven film (non-woven fabric), a microporous film, a composite film, a calendered film, a spinning film, or the like. The separator of this application may assume a porous structure. The porous layer is disposed on at least one surface of the separator. The porous layer includes inorganic particles and a binder. The inorganic particles may include at least one of aluminum oxide, silicon oxide, magnesium oxide, titanium oxide, hafnium dioxide, tin oxide, ceria, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder may include at least one of polyvinylidene fluoride, poly(vinylidene fluoride-co-hexafluoropropylene), a polyamide, polyacrylonitrile, polyacrylic ester, polyacrylic acid, sodium polyacrylate, sodium carboxymethyl cellulose, polyvinylpyrrolidone, polyvinyl ether, polymethyl methacrylate, polytetrafluoroethylene, or polyhexafluoropropylene. The pore size of the porous structure is not particularly limited as long as the objectives of this application can be achieved. For example, the pore size may be 0.01 μm to 1 μm. The thickness of the separator is not particularly limited in this application, as long as the objectives of this application can be achieved. For example, the thickness may be 5 μm to 500 μm.

In this application, the electrolyte solution includes a lithium salt and a nonaqueous solvent. The lithium salt may include at least one of LiPF₆, LiBF₄, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato)borate (LiBOB), or lithium difluoroborate. The concentration of the lithium salt in the electrolyte solution is not particularly limited in this application, as long as the objectives of this application can be achieved. The nonaqueous solvent is not particularly limited herein, as long as the objectives of this application can be achieved. For example, the nonaqueous solvent may include, but is not limited to, at least one of a carbonate ester compound, a carboxylate ester compound, an ether compound, or other organic solvents. The carbonate ester compound may include, but is not limited to, at least one of a chain carbonate ester compound, a cyclic carbonate ester compound, or a fluorocarbonate ester compound. The chain carbonate ester compound may include, but is not limited to, at least one of dimethyl carbonate (DMC), diethyl carbonate (DEC), dipropyl carbonate (DPC), methyl propyl carbonate (MPC), ethylene propyl carbonate (EPC), or ethyl methyl carbonate (EMC). The cyclic carbonate ester compound may include, but is not limited to, at least one of ethylene carbonate (EC), propylene carbonate (PC), butylene carbonate (BC), or vinyl ethylene carbonate (VEC). The fluorocarbonate ester compound may include, but is not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate ester compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above-mentioned other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The type of the secondary battery is not particularly limited herein, and may be any device in which an electrochemical reaction occurs. For example, the types of the secondary battery may include, but are not limited to, a lithium metal secondary battery, a lithium-ion battery, a sodium-ion battery, a lithium polymer secondary battery, and a lithium-ion polymer secondary battery. The shape of the secondary battery is not particularly limited herein as long as the objectives of this application can be achieved.

The process of preparing the secondary battery is well known to a person skilled in the art, and is not particularly limited herein. For example, the preparation process may include, but is not limited to, the following steps: stacking the positive electrode plate, the separator, and the negative electrode plate in sequence, and performing operations such as winding and folding as required to obtain a jelly-roll electrode assembly; putting the electrode assembly into a package, injecting the electrolyte solution into the package, and sealing the package to obtain a secondary battery; or, stacking the positive electrode plate, the separator, and the negative electrode plate in sequence, and then fixing the four corners of the entire stacked structure by use of adhesive tape to obtain a stacked-type electrode assembly, putting the electrode assembly into a package, injecting the electrolyte solution into the package, and sealing the package to obtain a secondary battery. In addition, an overcurrent protection element, a conductive plate, and the like may be placed into a packaging bag as required, so as to prevent the rise of internal pressure, overcharge, and overdischarge of the secondary battery.

A second aspect of this application provides an electronic device, including the secondary battery according to the first aspect of this application. The secondary battery of this application is of high safety performance, and therefore, the electronic device provided in the second aspect of this application achieves a relatively long service life.

The electronic device is not particularly limited herein, and may be any electronic device known in the prior art. For example, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to some embodiments and comparative embodiments. Various tests and evaluations are performed by the following methods. In addition, unless otherwise specified, the word “parts” means parts by mass, and the symbol “%” means a percentage by mass.

### Test Methods and Devices

### Testing the Composition of a First Adhesive Layer

Disassembling a lithium-ion battery, taking out a first adhesive layer, and then determining the constituents in the first adhesive layer and a mass percent of each constituent in the first adhesive layer by performing a Fourier transform infrared spectroscopy (FTIR) test and using a pyrolysis-gas chromatography-mass spectrometry (PY-GCMS) mass spectrometer (GCMS).

### Testing Peel Strength

Measuring the peel strength between the adhesive member and the housing (packaging bag) by use of a High-Speed Rail Tensile Tester with reference to the standard GB/T 2792-2014 Measurement of Peel Adhesion Properties for Adhesive Tapes. The test process is as follows: Discharging a lithium-ion battery until the voltage reaches 0 V, and then disassembling the lithium-ion battery, removing, as a whole, an adhesive member as well as an electrode assembly part and a packaging bag part that are bonded to the adhesive member, and wiping off the electrolyte solution on the surface of the removed part by using dust-free paper. Subsequently, cutting the removed part into specimens, each being 20 mm×60 mm in size. Bonding the side, close to the electrode assembly, of the specimen onto a steel sheet by use of double-sided tape (Nitto 5000NS) along the length direction of the specimen, where the bonding length is not less than 40 mm. Fixing a steel sheet to a corresponding position on a GoTech tensile machine, pulling up the specimen from the other end not bonded to the adhesive member, and placing the specimen into a grip to get clamped. Leaving the pulled-up part of the specimen to be at an 180° angle to the steel sheet in space. Pulling the specimen at a speed of 5±0.2 mm/s by using the grip. Ultimately, recording an average of tensile forces in a steady region as the peel strength between the adhesive member and the housing, denoted as F, in units of N/m.

### Testing Peel Strength at Varying Temperatures

Preparing a lithium-ion battery according to the method in Embodiment 1-1, and setting the chemical formation temperature of the lithium-ion battery to 65° C., 75° C., 80° C., 85° C., and 90° C. to obtain five samples respectively. Preparing specimens according to the above method for testing the peel strength, and measuring the peel strength between the adhesive member and the housing of the five samples separately according to the method for testing the peel strength, in units of N/m.

### Testing a Static Friction Coefficient

Measuring the friction coefficient between the first adhesive layer and the inner surface of the housing by using an MXD-02 friction coefficient tester with reference to the standard GB/T 10006-2021 Plastics—Film and Sheeting—Determination of the Coefficients of Friction. The test process is as follows: Placing a test board on a horizontal worktop, bonding an adhesive member to aluminum foil through a second adhesive layer, and cutting the foil into specimens, each being 50 mm×50 mm in size. Soaking the specimen in an electrolyte solution at 85° C. for 4 h. Wiping off the electrolyte solution on the surface with dust-free paper after completion of soaking. Fixing the specimen onto the test board with double-sided tape (Nitto 5000NS) at room temperature, denoted as a first specimen. Cutting the packaging bag into specimens, each being 100 mm×100 mm in size and serving as a second specimen. Fixing the second specimen onto a slide block with a weight of 65 g. Placing test surfaces of two specimens opposite to each other horizontally. Applying a contact pressure evenly, and making the surfaces of the two specimens move relative to each other. Recording the force required for starting to slide (static friction). The static friction divided by the gravity of the slide block is the static friction coefficient, that is, the friction coefficient x between the first adhesive layer and the inner surface of the housing. The preparation method for the above electrolyte solution is the same as that for the electrolyte solution in Embodiment 1-1.

### Tumble Test

Leaving a lithium-ion battery to stand for 60 minutes at room temperature, and then measuring the voltage of the lithium-ion battery before the tumble test. Loading the lithium-ion battery into a fixture, and performing a test by using a tumble drum in a test environment of 20±5° C. Placing the lithium-ion battery at 1 μm above the ground, subjecting the lithium-ion battery to 250 free-fall cycles at a speed of 12 cycles per minute (1 cycle includes 2 drops). Measuring and recording the voltage of the lithium-ion battery again after completion of the test. Inspecting and photographing the battery appearance both before and after the test. Evaluation criteria for the tumble test: The test is passed if no smoke or electrolyte leak occurs and the voltage drop is less than 50 mV.

### Drop Test

Pre-treating a lithium-ion battery at 25° C., leaving the battery to stand for 60 minutes at normal temperature, and then measuring the voltage of the lithium-ion battery before the drop test. Fixing the lithium-ion battery into a fixture, subjecting the battery to free-fall drops at 1.5 μm from the ground by using a drop tester, and letting the following six parts of the battery hit the landing point sequentially: head, tail, right head corner, right tail corner, left head corner, and left tail corner (at an angle of 45±15°), thereby completing one round. Repeating the free-fall drops for 6 rounds. Measuring and recording the voltage of the lithium-ion battery after completion of the drop test, and inspecting and photographing the appearance of the lithium-ion battery both before and after the drop test. Evaluation criteria for the drop test: The test is passed if no smoke or electrolyte leak occurs and the voltage drop is less than 30 mV.

### Testing an Electrolyte Retention Coefficient

Charging a lithium-ion battery at 0.5 C in a 25° C. environment until the voltage reaches 4.5 V, and then charging the battery at a constant voltage until the current tapers off to 0.05 C. Leaving the battery to stand for 5 minutes, and then discharging the battery at 0.1 C until the voltage drops to 3 V Recording the discharge capacity Cₚ. Disassembling the lithium-ion battery, centrifuging the battery in a high-speed centrifuge to obtain a free electrolyte solution. Weighing and recording the mass m of the electrolyte solution. Calculating the electrolyte retention coefficient of the lithium-ion battery as y=m/Cₚ, in g/Ah.

### Testing Swelling Characteristics

Cutting the adhesive members in the embodiments and comparative embodiments into specimens, each being 50 mm×50 mm in size. Measuring the mass of the specimen, denoted as a gram. Soaking the specimen in an electrolyte solution at 85° C. for 7 days, and then observing the morphology of the adhesive member after the soaking, and measuring the mass, denoted as b gram. Calculating the swelling rate as: swelling rate=(b−a)/b×100%. Determining the swelling characteristics based on the swelling rate. If the swelling rate of the adhesive member falls within the range of 5% to 30%, it is determined that the adhesive member exhibits good swelling characteristics.

The preparation method for the above electrolyte solution is the same as that for the electrolyte solution in Embodiment 1-1.

### Embodiment 1-1

### Preparing a Positive Electrode Plate

Mixing LiCoO₂ as a positive active material, conductive carbon black as a conductive agent, and polyvinylidene fluoride (PVDF) as a binder at a mass ratio of 97.5:1:1.5, and adding N-methyl-pyrrolidone (NMP) as a solvent to formulate a slurry in which the solid content is 75 wt %, and stirring well. Applying the slurry evenly onto one surface of a 9 μm-thick positive current collector aluminum foil, and drying the foil at 90° C. to obtain a positive electrode plate coated with a 110 μm-thick coating layer. The coating on a single side of the positive electrode plate is completed upon completion of the above steps. Subsequently, repeating the above steps on the other surface of the positive electrode plate to obtain a positive electrode plate coated with a positive active material on both sides. Performing cold-pressing, cutting, and slitting for the coated electrode plate, and drying the electrode plate in an 85° C. vacuum environment for 4 hours to obtain a positive electrode plate of 35 mm×867 mm in size.

### Preparing a Negative Electrode Plate

Mixing graphite powder as a negative active material, conductive carbon black (Super P) as a conductive agent, and styrene butadiene rubber (SBR) as a binder at a mass ratio of 96:1.5:2.5, and then adding deionized water as a solvent to formulate a slurry in which the solid content is 70 wt %, and stirring well. Applying the slurry evenly onto one surface of an 5 μm-thick negative current collector copper foil, and drying the foil at 110° C. to obtain a negative electrode plate coated with a 130 μm-thick negative active material on a single side. The coating on a single side of the negative electrode plate is completed upon completion of the above steps. Subsequently, repeating the foregoing steps on the other surface of the negative electrode plate to obtain a negative electrode plate coated with the negative active material on both sides. Performing cold-pressing, cutting, and slitting for the coated electrode plate, and drying the electrode plate in an 120° C. vacuum environment for 12 hours to obtain a negative electrode plate of 37.5 mm×875 mm in size.

### Preparing a Separator

Mixing PVDF and alumina ceramics at a mass ratio of 9:1, and adding deionized water as a solvent to formulate a slurry in which the solid content is 25 wt %. Stirring well, and then applying the slurry evenly onto one surface of a 5 μm-thick polyethylene porous polymer film (supplied by Celgard), and oven-drying the polymer film. Applying the slurry evenly onto the other surface of the polyethylene porous polymer film to obtain a separator coated with a 2 μm-thick alumina ceramics layer on both sides.

### Preparing an Electrolyte Solution

Mixing ethylene carbonate, ethyl methyl carbonate, and diethyl carbonate at a mass ratio of 30:50:20 in an dry argon atmosphere to obtain an organic solution, and then adding LiPF₆ as a lithium salt into the organic solvent to dissolve, and stirring well to obtain an electrolyte solution in which the lithium salt concentration is 1.15 mol/L.

### Preparing a Binder

Mixing well poly(styrene-b-isoprene-b-styrene) (SIS, with a weight-average molecular weight of 100,000), poly(acrylonitrile-co-butadiene-co-styrene) (ABS, with a weight-average molecular weight of 300,000) as a first resin, poly(ethylene-vinyl acetate) (EVA, with a weight-average molecular weight of 120,000) as a functional resin, titanium dioxide powder as an additive, and diphenylamine as an antioxidant. Heating the mixture to 150° C. to hot-melt the mixture, and then applying the hot-melted product onto one surface of an 8 μm-thick polyethylene terephthalate film (PET) substrate layer. Subsequently, drying the applied product at 120° C. to form a first adhesive layer with a thickness of 8 μm. Applying polyacrylic acid (PAA) on the other surface of the substrate layer, and drying the PAA at 80° C. to form a second adhesive layer with a thickness of 4 μm, thereby obtaining an adhesive member containing the first adhesive layer, the substrate layer, and the second adhesive layer stacked sequentially. Based on the mass of the first adhesive layer, the mass percent of the SIS is 45%, the mass percent of the first resin ABS is 30%, the mass percent of the functional resin EVA is 15%, the mass percent of the additive titanium dioxide powder is 5%, and the mass percent of the antioxidant diphenylamine is 5%. The mass ratio between the three monomers of the ABS is as follows: acrylonitrile:butadiene:styrene=20:35:45.

### Preparing a Lithium-Ion Battery

Stacking the above-prepared positive electrode plate, separator, and negative electrode plate in sequence in such a way that the separator is located between the positive electrode plate and the negative electrode plate to serve a function of separation, and winding the stacked structure to obtain a jelly-roll electrode assembly. Affixing the above-prepared adhesive member onto the outer surface of the electrode assembly through the second adhesive layer, and then placing the electrode assembly into an aluminum laminated film packaging bag. Subsequently, subjecting the packaged electrode assembly to processes such as top sealing, side sealing, vacuum drying, electrolyte injection, chemical formation (at a temperature of 85° C., a pressure of 1.05 MPa, and a voltage of 3.5 V), capacity grading, and degassing to obtain a lithium-ion battery. The electrolyte retention coefficient of the lithium-ion battery is 1.75 g/Ah. The dimensions of the first adhesive layer are 20 mm×30 mm, and the dimensions of an orthographic projection of the electrode assembly along the stacking direction of the electrode assembly, the adhesive member, and the housing are 30 mm×40 mm. In other words, S₁=600 mm², and S₂=1200 mm².

### Embodiments 1-2 to 1-18

Identical to Embodiment 1-1 except that the preparation parameters are adjusted according to Table 1.

### Embodiments 2-1 to 2-3

Identical to Embodiment 1-1 except that the thickness of the first adhesive layer is adjusted according to Table 2.

### Embodiments 2-4 to 2-7

Identical to Embodiment 1-1 except that the area S₁ of the first adhesive layer and the area S₂ of an orthographic projection of the electrode assembly along a stacking direction of the electrode assembly, the adhesive member, and the housing, are adjusted according to Table 2. With the change of the area S₁ of the first adhesive layer, the length and width of the first adhesive layer are scaled proportionally.

### Embodiments 2-8 to 2-9

Identical to Embodiment 1-1 except that the electrolyte retention coefficient y is adjusted according to Table 2.

### Comparative Embodiment 1

Identical to Embodiment 1-1 except that the first adhesive layer contains no first resin and the preparation parameters are adjusted according to Table 1.

The relevant preparation parameters and performance test results of the embodiments and comparative embodiments are shown in Table 1 and Table 2.

TABLE 1

| | | Mass | | | Mass | |
|---|---|---|---|---|---|---|
| | Mass | percent of | Type | | percent of | Mass |
| | percent of | first | of first | Constituents | functional | percent of |
| | SIS (%) | resin (%) | resin | of ABS | resin (%) | additive (%) |
| Embodiment 1-1 | 45 | 30 | ABS | 20:35:45 | 15 | 5 |
| Embodiment 1-2 | 60 | 15 | ABS | 20:35:45 | 15 | 5 |
| Embodiment 1-3 | 55 | 20 | ABS | 20:35:45 | 15 | 5 |
| Embodiment 1-4 | 50 | 25 | ABS | 20:35:45 | 15 | 5 |
| Embodiment 1-5 | 40 | 35 | ABS | 20:35:45 | 15 | 5 |
| Embodiment 1-6 | 35 | 40 | ABS | 20:35:45 | 15 | 5 |
| Embodiment 1-7 | 75 | 15 | ABS | 20:35:45 | 8 | 1 |
| Embodiment 1-8 | 50 | 40 | ABS | 20:35:45 | 6 | 2 |
| Embodiment 1-9 | 50 | 28 | ABS | 20:35:45 | 12 | 5 |
| Embodiment 1-10 | 50 | 15 | ABS | 20:35:45 | 25 | 5 |
| Embodiment 1-11 | 45 | 30 | ABS | 5:50:45 | 15 | 5 |
| Embodiment 1-12 | 45 | 30 | ABS | 35:55:10 | 15 | 5 |
| Embodiment 1-13 | 45 | 30 | ABS | 35:20:45 | 15 | 5 |
| Embodiment 1-14 | 45 | 30 | ABS | 30:40:30 | 15 | 5 |
| Embodiment 1-15 | 45 | 30 | Polyurethane | / | 15 | 5 |
| Embodiment 1-16 | 45 | 30 | Polystyrene | / | 15 | 5 |
| Embodiment 1-17 | 90 | 5 | ABS | 20:35:45 | 3 | 1 |
| Embodiment 1-18 | 20 | 55 | ABS | 20:35:45 | 15 | 5 |
| Comparative | 78 | 0 | / | / | 12 | 5 |
| Embodiment 1 | | | | | | |

| | | | | Number of | Number of |
|---|---|---|---|---|---|
| | Mass | | | failed specimens | failed specimens |
| | percent of | | F | to total number | to total number |
| | antioxidant (%) | x | (N/m) | in tumble test | in drop test |
| Embodiment 1-1 | 5 | 0.65 | 182 | 0/20 | 0/20 |
| Embodiment 1-2 | 5 | 0.35 | 301 | 3/20 | 4/20 |
| Embodiment 1-3 | 5 | 0.44 | 254 | 1/20 | 3/20 |
| Embodiment 1-4 | 5 | 0.56 | 211 | 0/20 | 0/20 |
| Embodiment 1-5 | 5 | 0.73 | 165 | 0/20 | 0/20 |
| Embodiment 1-6 | 5 | 0.85 | 127 | 2/20 | 3/20 |
| Embodiment 1-7 | 1 | 0.32 | 384 | 1/20 | 2/20 |
| Embodiment 1-8 | 2 | 0.79 | 209 | 1/20 | 1/20 |
| Embodiment 1-9 | 5 | 0.62 | 202 | 0/20 | 0/20 |
| Embodiment 1-10 | 5 | 0.31 | 213 | 2/20 | 2/20 |
| Embodiment 1-11 | 5 | 0.64 | 179 | 0/20 | 0/20 |
| Embodiment 1-12 | 5 | 0.63 | 177 | 0/20 | 0/20 |
| Embodiment 1-13 | 5 | 0.62 | 180 | 0/20 | 0/20 |
| Embodiment 1-14 | 5 | 0.65 | 183 | 0/20 | 0/20 |
| Embodiment 1-15 | 5 | 0.58 | 181 | 0/20 | 0/20 |
| Embodiment 1-16 | 5 | 0.67 | 180 | 0/20 | 0/20 |
| Embodiment 1-17 | 1 | 0.19 | 512 | 7/20 | 7/20 |
| Embodiment 1-18 | 5 | 0.94 | 43 | 8/20 | 9/20 |
| Comparative | 5 | 0.11 | 417 | 16/20 | 19/20 |
| Embodiment 1 | | | | | |

Note:
“/” in Table 1 indicates absence of the relevant parameter, x is the friction coefficient between the first adhesive layer and the inner surface of the housing, and F is the peel strength between the adhesive member and the housing. The weight-average molecular weight of the polyurethane is 800,000, and the weight-average molecular weight of the polystyrene is 200,000.

As can be seen from Embodiments 1-1 to 1-10, Embodiments 1-17 to 1-18, and Comparative Embodiment 1, when the first adhesive layer contains no first resin, such as in Comparative Embodiment 1, although the peel strength between the adhesive member and the housing is relatively high, the friction coefficient between the first adhesive layer and the inner surface of the housing is small. When the first adhesive layer contains no first resin, the friction coefficient between the first adhesive layer and the inner surface of the housing, and the peel strength between the adhesive member and the housing, are not satisfactory concurrently. When the first adhesive layer includes the SIS and the first resin, both the friction coefficient between the first adhesive layer and the inner surface of the housing and the peel strength between the adhesive member and the housing are satisfactory, the values of both x and F are relatively large, and the ratio of the number of failed specimens to the total number of specimens in the tumble test and the drop test is lower, indicating that the lithium-ion battery exhibits higher safety performance.

The mass percentages of the SIS and the first resin affect the safety performance of the lithium-ion battery. As can be seen from Embodiments 1-1 to 1-10 and Embodiments 1-17 to 1-18, by adjusting and controlling the mass percentages of the SIS and the first resin to fall within the ranges specified herein, both the friction coefficient between the first adhesive layer and the inner surface of the housing and the peel strength between the adhesive member and the housing are satisfactory, the values of both x and F are relatively large, and the ratio of the number of failed specimens to the total number of specimens in the tumble test and the drop test of the lithium-ion battery is lower, indicating that the lithium-ion battery exhibits higher safety performance.

The type of the first resin affects the safety performance of the lithium-ion battery. As can be seen from Embodiment 1-1 and Embodiments 1-11 to 1-16, when the type of the first resin falls within the range specified herein, both the friction coefficient between the first adhesive layer and the inner surface of the housing and the peel strength between the adhesive member and the housing are satisfactory, the values of both x and F are relatively large, and the ratio of the number of failed specimens to the total number of specimens in the tumble test and the drop test is relatively low, indicating that the lithium-ion battery exhibits good safety performance.

When the first resin is poly(acrylonitrile-co-butadiene-co-styrene), the mass percentages of the monomers of the poly(acrylonitrile-co-butadiene-co-styrene) affect the safety performance of the lithium-ion battery. As can be seen from Embodiment 1-1 and Embodiments 1-11 to 1-14, when the mass percentages of the monomers of the poly(acrylonitrile-co-butadiene-co-styrene) fall within the ranges specified herein, both the friction coefficient between the first adhesive layer and the inner surface of the housing and the peel strength between the adhesive member and the housing are satisfactory, and the values of both x and F are relatively large, thereby improving the bonding performance of the first adhesive layer, and alleviating the problems of undesirable electrolyte-induced expansion on the surface and four corners of the electrode assembly. The ratio of the number of failed specimens to the total number of specimens in the tumble test and the drop test is relatively low, indicating that the lithium-ion battery exhibits good safety performance.

The change in the mass percent of the functional resin affects the friction coefficient x between the first adhesive layer and the inner surface of the housing and the peel strength F between the adhesive member and the housing, thereby affecting the safety performance of the lithium-ion battery. As can be seen from Embodiment 1-1 and Embodiments 1-7 to 1-10, when the mass percent of the functional resin falls within the range specified herein, both the friction coefficient between the first adhesive layer and the inner surface of the housing and the peel strength between the adhesive member and the housing are satisfactory, the values of both x and F are relatively large, and the ratio of the number of failed specimens to the total number of specimens in the tumble test and the drop test is relatively low, indicating that the lithium-ion battery exhibits good safety performance.

The change in the mass percentages of the additive and the antioxidant affects the friction coefficient x between the first adhesive layer and the inner surface of the housing and the peel strength F between the adhesive member and the housing, thereby affecting the safety performance of the lithium-ion battery. As can be seen from Embodiment 1-1 and Embodiments 1-7 to 1-9, when the mass percentages of the additive and the antioxidant fall within the ranges specified herein, both the friction coefficient between the first adhesive layer and the inner surface of the housing and the peel strength between the adhesive member and the housing are satisfactory, the values of both x and F are relatively large, and the ratio of the number of failed specimens to the total number of specimens in the tumble test and the drop test is relatively low, indicating that the lithium-ion battery exhibits good safety performance.

The peel strength between the adhesive member and the packaging bag in Embodiment 1-7 varies with temperature as follows: When the chemical formation temperature of the lithium-ion battery is 65° C., 75° C., 80° C., 85° C., and 90° C., the peel strength between the adhesive member and the packaging bag in Embodiment 1-7 of this application is 376 N/m, 379 N/m, 383 N/m, 384 N/m, and 387 N/m, respectively. As can be seen, the peel strength between the adhesive member and the packaging bag in Embodiments 1-7 remains at the same level when the chemical formation temperature is 65° C. to 90° C., thereby broadening the process window (65° C. to 90° C.) of the chemical formation process of the lithium-ion battery. This is because the molecular chain of the first resin in the first adhesive layer is more flexible, the cohesive force of the first adhesive layer is relatively low, and the viscosity can be quickly exerted at a relatively low temperature (65° C.). The peel strength between the adhesive member and the packaging bag in Comparative Embodiment 1 varies with temperature as follows: When the chemical formation temperature of the lithium-ion battery is 65° C., 75° C., 80° C., 85° C., and 90° C., the peel strength between the adhesive member and the packaging bag in Comparative Embodiment 1 is 37 N/m, 142 N/m, 417 N/m, 423 N/m, and 434 N/m, respectively. As can be seen, the peel strength gradually increases and then remains constant, resulting in a narrow process window (80° C. to 90° C.) in the chemical formation process of the lithium-ion battery.

The adhesive members in Embodiment 1-1 and Comparative Embodiment 1 of this application are cut into cuboids, each weighing 5 g. After being soaked in an electrolyte solution at 85° C. for 24 hours, the adhesive member in Embodiment 1-1 of this application swells to 5.720 g, with a swelling rate of 14.4%. By contrast, the adhesive member in Comparative Embodiment 1 swells to 6.805 g, with a swelling rate of 36.1%, and without forming a stable shape. This indicates that the adhesive member of this application can swell in the electrolyte solution and form a stable shape.

TABLE 2

| | Thickness | | | | | | Number of | Number of |
|---|---|---|---|---|---|---|---|---|
| | of first | | | | | | failed specimens | failed specimens |
| | adhesive | | | y | | F | to total number | to total number |
| | layer (μm) | S₁ (mm²) | S₁/S₂ | (g/Ah) | x | (N/m) | in tumble test | in drop test |
| Embodiment 1-1 | 8 | 600 | 50% | 1.75 | 0.65 | 182 | 0/20 | 0/20 |
| Embodiment 2-1 | 2 | 600 | 50% | 1.75 | 0.64 | 104 | 0/20 | 1/20 |
| Embodiment 2-2 | 15 | 600 | 50% | 1.75 | 0.63 | 315 | 0/20 | 0/20 |
| Embodiment 2-3 | 20 | 600 | 50% | 1.75 | 0.66 | 384 | 0/20 | 1/20 |
| Embodiment 2-4 | 8 | 120 | 10% | 1.75 | 0.61 | 181 | 3/20 | 4/20 |
| Embodiment 2-5 | 8 | 360 | 30% | 1.75 | 0.65 | 179 | 2/20 | 1/20 |
| Embodiment 2-6 | 8 | 840 | 70% | 1.75 | 0.62 | 185 | 0/20 | 0/20 |
| Embodiment 2-7 | 8 | 1140 | 95% | 1.75 | 0.65 | 175 | 0/20 | 0/20 |
| Embodiment 2-8 | 8 | 600 | 50% | 1 | 0.63 | 181 | 0/20 | 0/20 |
| Embodiment 2-9 | 8 | 600 | 50% | 2.5 | 0.64 | 184 | 0/20 | 0/20 |

Note:
In Table 2, y is an electrolyte retention coefficient, x is a friction coefficient between the first adhesive layer and the inner surface of the housing, and F is the peel strength between the adhesive member and the housing.

The thickness of the first adhesive layer affects the safety performance of the lithium-ion battery. As can be seen from Embodiment 1-1 and Embodiments 2-1 to 2-3, when the thickness of the first adhesive layer falls within the range specified herein, both the friction coefficient between the first adhesive layer and the inner surface of the housing and the peel strength between the adhesive member and the housing are satisfactory, the values of both x and F are relatively large, and the ratio of the number of failed specimens to the total number of specimens in the tumble test and the drop test is relatively low, indicating that the lithium-ion battery exhibits good safety performance.

The value of S₁/S₂ affects the safety performance of the lithium-ion battery. As can be seen from Embodiment 1-1 and Embodiments 2-4 to 2-7, when the value of S₁/S₂ falls within the range specified herein, both the friction coefficient between the first adhesive layer and the inner surface of the housing and the peel strength between the adhesive member and the housing are satisfactory, the values of both x and F are relatively large, and the ratio of the number of failed specimens to the total number of specimens in the tumble test and the drop test is relatively low, indicating that the lithium-ion battery exhibits good safety performance.

The electrolyte retention coefficient of the secondary battery affects the safety performance of the lithium-ion battery. As can be seen from Embodiment 1-1 and Embodiments 2-8 to 2-9, when the electrolyte retention coefficient of the secondary battery falls within the range specified herein, both the friction coefficient between the first adhesive layer and the inner surface of the housing and the peel strength between the adhesive member and the housing are satisfactory, the values of both x and F are relatively large, and the ratio of the number of failed specimens to the total number of specimens in the tumble test and the drop test is relatively low, indicating that the lithium-ion battery exhibits good safety performance.

Described above are merely preferred embodiments of this application that are not intended to limit this application. Any modifications, equivalent replacements, improvements, and the like made without departing from the concept and principles of this application still fall within the protection scope of this application.

What is claimed is:

1. A secondary battery, comprising an electrode assembly, an electrolyte solution, a housing, and an adhesive member; wherein the adhesive member is disposed between the electrode assembly and the housing;
the adhesive member comprises a first adhesive layer and a second adhesive layer stacked together, the first adhesive layer is bonded to an inner surface of the housing, the second adhesive layer is bonded to an outer surface of the electrode assembly, the first adhesive layer comprises poly(styrene-b-isoprene-b-styrene) and a first resin; and the first resin comprises at least one of poly(acrylonitrile-co-butadiene-co-styrene), polyurethane, or polystyrene.

2. The secondary battery according to claim 1, wherein based on a mass of the first adhesive layer, a mass percentage of the poly(styrene-b-isoprene-b-styrene) is 32.5% to 75%, and a mass percentage of the first resin is 15% to 45%.

3. The secondary battery according to claim 1, wherein, based on a mass of the first adhesive layer, a mass percentage of the first resin is 20% to 40%.

4. The secondary battery according to claim 1, wherein, based on a mass of the first adhesive layer, a mass percentage of the first resin is 25% to 35%.

5. The secondary battery according to claim 1, wherein the first adhesive layer further comprises a functional resin; a mass percentage of the functional resin is 5% to 25% based on a mass of the first adhesive layer; and the functional resin comprises at least one of poly(ethylene-co-vinyl acetate), a polyurethane elastomer, polyurethane acrylate, polyisobutylene, or polybutadiene.

6. The secondary battery according to claim 1, wherein, the first adhesive layer further comprises an additive and an antioxidant; and based on a mass of the first adhesive layer, a mass percentage of the additive is 1% to 5%, and a mass percentage of the antioxidant is 1% to 5%.

7. The secondary battery according to claim 1, wherein the adhesive member further comprises a substrate layer, the substrate layer is located between the first adhesive layer and the second adhesive layer; and the substrate layer comprises at least one of polyethylene terephthalate, polyimide, or polypropylene.

8. The secondary battery according to claim 1, wherein an area of the first adhesive layer is S₁; an area of an orthographic projection of the electrode assembly along a stacking direction of the electrode assembly, the adhesive member, and the housing is S₂; and 10%≤S₁/S₂≤95%.

9. The secondary battery according to claim 1, wherein the housing is a packaging bag.

10. The secondary battery according to claim 1, wherein a thickness of the first adhesive layer is 2 μm to 20 μm.

11. The secondary battery according to claim 1, wherein a peel strength between the adhesive member and the housing is 10 N/m to 500 N/m.

12. The secondary battery according to claim 9, wherein an electrolyte retention coefficient of the secondary battery is 1 g/Ah to 2.5 g/Ah.

13. The secondary battery according to claim 1, wherein a thickness of the second adhesive layer is 2 μm to 10 μm, and a thickness of the substrate layer of the second adhesive layer is 4 μm to 30 μm.

14. An electronic device, comprising the secondary battery according to claim 1.

15. The electronic device according to claim 14, wherein based on a mass of the first adhesive layer, a mass percentage of the poly(styrene-b-isoprene-b-styrene) is 32.5% to 75%, and a mass percentage of the first resin is 15% to 45%.

16. The electronic device according to claim 14, wherein, based on a mass of the first adhesive layer, a mass percentage of the first resin is 20% to 40%.

17. The electronic device according to claim 14, wherein, based on a mass of the first adhesive layer, a mass percentage of the first resin is 25% to 35%.

18. The electronic device according to claim 14, wherein the first adhesive layer further comprises a functional resin; a mass percent of the functional resin is 5% to 25% based on a mass of the first adhesive layer; and the functional resin comprises at least one of poly(ethylene-co-vinyl acetate), a polyurethane elastomer, polyurethane acrylate, polyisobutylene, or polybutadiene.

19. The electronic device according to claim 14, wherein, the first adhesive layer further comprises an additive and an antioxidant; and based on a mass of the first adhesive layer, a mass percentage of the additive is 1% to 5%, and a mass percentage of the antioxidant is 1% to 5%.

20. The electronic device according to claim 14, wherein the adhesive member further comprises a substrate layer, the substrate layer is located between the first adhesive layer and the second adhesive layer; and the substrate layer comprises at least one of polyethylene terephthalate, polyimide, or polypropylene.
